(19) United States
(12) Patent Application Publication
(10) Pub. No.: US 2010/0185761 A1
(43) Pub. Date: Jul. 22, 2010

(54) SERVICE PROVIDER NODE, AND COMPUTER-READABLE RECORDING MEDIUM STORING SERVICE PROVIDER PROGRAM

(75) Inventors: Tetsutaro MARUYAMA, Kawasaki (JP); Yoshihiro Tsuchiya, Kawasaki (JP); Masahisa Tamura, Kawasaki (JP); Hideki Sakurai, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/685,453

(22) Filed: Jan. 11, 2010

(30) Foreign Application Priority Data
Jan. 22, 2009 (JP) 2009-011504

(51) Int. Cl. G06F 9/54; G06F 15/173

(52) U.S. Cl. 709/224; 719/313

(57) ABSTRACT

A computer-readable recording medium storing a verification support program is provided. The computer-readable recording medium storing a service provider program that causes a computer to execute: providing a service through acceptance of a service request; establishing a process-to-process communications by waiting for a process to be a destination of the service; stopping provision of the service corresponding to the service request accepted by the providing after the process-to-process communications is established; transmitting, while the provision of the service is being stopped, information for use by the providing to provide the service, to the process by the process-to-process communications; and ending, after the information is completely transmitted by the transmitting, the acceptance of the service request by the providing.

### CROSS-REFERENCE TO RELATED APPLICATION

This application is based upon and claims the benefit of priority of the prior Japanese Patent Application No. 2009-011504, filed on Jan. 22, 2009, the entire contents of which are incorporated herein by reference.

### FIELD

An aspect of embodiments of the present invention relates to a service provider node that provides a service, a computer-readable recording medium storing a service provider program, and to a service provider node that updates software while continuing service operations.

### BACKGROUND

With a cluster system, a plurality of computers is used for decentralized processing. The computers making up the cluster system are referred to as nodes. In the cluster system, always recognizing whether such nodes are operating normally or not is required to determine which of the nodes is to be assigned processing procedures.

For recognizing the state of service operations of the nodes in the cluster system, there is a method for providing heartbeats at regular intervals from the nodes to a monitoring node. The heartbeats are information indicating that the nodes providing the heartbeats are operating normally. The monitoring node determines only nodes providing the heartbeats at regular intervals as nodes operating normally.

When detecting a node not providing heartbeats at regular intervals, the monitoring node determines that the node has a failure, and eliminates the node from a list of nodes to perform processing procedures. When the node eliminated from the list of nodes to perform the processing procedures recovers from the failure, the recovered node is made available again for the service operations. When the service operations are resumed as such, the monitoring node adds the node back to the list of nodes to perform the processing procedures.

Note here that the information such as heartbeats to be provided at regular intervals can be closer to “real-time” with a shorter interval, but a shorter interval causes an increase in communications load. In consideration thereof, there is a technology under study for changing the interval of periodic transmission based on the state of communications (Japanese Unexamined Patent Application Publication No. 2004-364168).

During the service operations in the cluster system, some need may arise for software updates for any of the nodes. When such a need arises, generally, the operation of a node requiring a software update is stopped, and then the software update is accordingly started. As such, during the software update, the provision of service is temporarily stopped by the node. The issue here is that, when the provision of service is stopped as such, the monitoring node detects the node as having a failure, and an error procedure is accordingly executed. However, the software update is not an error, and once the software update is completed, it is evident that the service operations are started normally with no problem. Therefore, if an error procedure is executed as such, it means that the procedure execution is needless, thereby resultantly causing the reduction of operation efficiency.

To overcome such an issue, various technologies have been proposed for software updating without causing the provision of service to stop. For example, a cluster system is provided with an agent for provision of service and with a cluster control section for controlling the agent while communicating with other computers in the cluster system. The cluster system of such a configuration performs software upgrades in the cluster control section while the agent is continuously providing the service (Japanese Unexamined Patent Application Publication No. 2005-85114).

### SUMMARY

In accordance with an aspect of embodiments, a computer-readable recording medium storing a service provider program causes a computer to execute: providing a service by accepting a service request; establishing a process-to-process communications by waiting for a process to be a destination of the service; stopping a provision of the service corresponding to the service request accepted by the providing after the process-to-process communications is established; transmitting, while the provision of the service is stopped, information for use by the providing to provide the service, to the process by the process-to-process communications; and ending, after the information is transmitted by the transmitting, the acceptance of the service request by the providing.

Other embodiments in which any components, representations, or any combinations of components of the cluster system control program disclosed herein are applied to a method, apparatus, system, computer program, recording medium, or data structure are also effective.

### BRIEF DESCRIPTION OF DRAWINGS

FIG. 1 is a diagram illustrating the general outline of an embodiment;

FIG. 2 is a diagram illustrating an exemplary configuration of a cluster system of the embodiment;

FIG. 3 is a diagram illustrating an exemplary hardware configuration of a monitoring node of the embodiment;

FIG. 4 is a function block diagram of a decentralized processing system;

FIG. 5 is a function block diagram of a server;

FIG. 6 is a diagram illustrating an exemplary data configuration of a heartbeat packet;

FIG. 7 is a sequence diagram of a software update procedure;

FIG. 8 is another sequence diagram of the software update procedure;

FIG. 9 illustrates a flowchart of a heartbeat communications procedure;

FIG. 10 illustrates a flowchart of a service communications procedure;

FIG. 11 illustrates a flowchart of a process-to-process communications procedure;

FIG. 12 illustrates another flowchart of the process-to-process communications procedure; and

FIG. 13 illustrates a flowchart of a new process activation procedure.

### DESCRIPTION OF EMBODIMENTS

Even with the previous technology for providing a service by the agent, there is still no choice but to stop the provision of service during the software update in the agent for provision of service. When the provision of service by the agent, e.g., the node, is stopped, a transmission source of the service request responsively interprets the stoppage as a failure occurring to a node being a source of the service provision.

The cluster system of the previous technologies removes any node detected as being in failure from a group of nodes to provide services. After the node is through with a software update procedure, the resulting node is added back to the group of nodes to provide services. Until the completion of the procedure for software update to the node, no service is provided from the node.

Repeating the procedure for every software update of the nodes, that is, eliminating the applicable node from a group of nodes to provide services and adding the node back to the group of nodes after the completion of the software update therein, lengthens the period of time during which the provision of service is stopped. Especially when the software update is performed to every node in the cluster system large in size, node addition and elimination during the software update causes the reduction of operation efficiency in the entire system.

An invention is proposed in consideration of such previous issues, and an object thereof is to provide a service provider node, a service provider program, and a software update method with which an external device may still recognize that nodes providing services are all in the normal state of operation while the nodes are being subjected to software update.

An embodiment of the invention is described below by referring to the accompanying drawings.

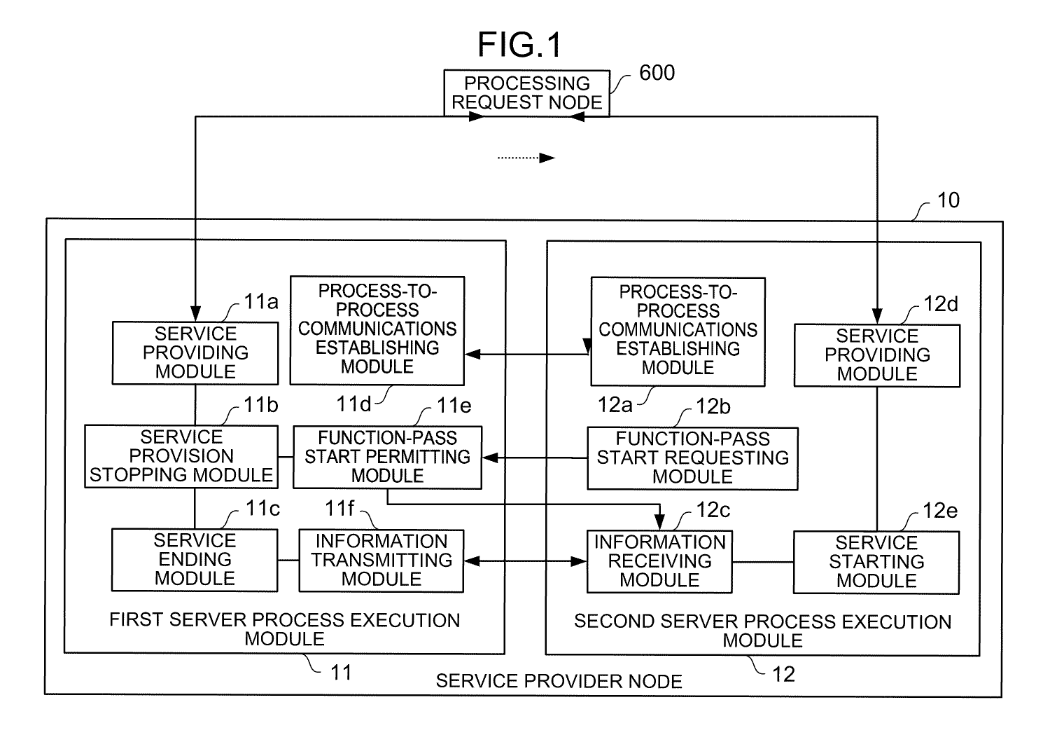

FIG. 1 is a diagram illustrating the general outline of the embodiment. A service provider node 10 of the embodiment configures a cluster system, and provides a service in response to a service request from a processing request node 600. The service provider node 10 includes a first server process execution module 11 and a second server process execution module 12. These first and second server process execution modules 11 and 12 each have a server function of providing a service with respect to the processing request node 600. The second server process execution module 12 is a server process operating by a revised program of the first server process execution module 11. While the first server process execution module 11 is operating as a source of the server function, and while the second server process execution module 12 is operating as a destination thereof, the server function is passed on.

The first server process execution module 11 is configured to include a service providing module 11a, a process-to-process communications establishing module 11d, a function-pass start permitting module 11e, a service provision stopping module 11b, an information transmitting module 11f, and a service ending module 11c.

The second server process execution module 12 is configured to include a service providing module 12d, a process-to-process communications establishing module 12a, a function-pass start requesting module 12b, an information receiving module 12c, and a service starting module 12e.

The service providing module 11a provides a service after accepting a service request from the processing request node 600. The second server process execution module 12 starts a procedure of passing the server function when any specific conditions are satisfied, e.g., in response to a timer or a command from external devices. The process-to-process communications establishing module 12a establishes any process-to-process communications set in advance with the first server process execution module 11. To establish the process-to-process communications, setting of the information related to the communications destination by the process-to-process communications establishing module 12a is made known in advance, and the process-to-process communications establishing module 11d releases the communications resources and waits for an access from the second server process execution module 12.

After establishing the process-to-process communications, the second server process execution module 12 makes a request for starting a procedure of passing the server function using the function-pass start requesting module 12b. The function-pass procedure is executed to set the service providing module 11a of the first server process execution module 11 as a source of the server function, and to set the service providing module 12d of the second server process execution module 12 as a destination of the server function. In order to determine whether the service providing module 12d is appropriate or not as a server to be provided with the server function, the function-pass start permitting module 11e checks the correctness of the server by software authentication and version check. When the correctness is verified, permission is given to start the function-pass procedure to set the service providing module 12d as a destination of the service to be provided by the service providing module 11a.

The service provision stopping module 11b stops the provision of service by making a response, e.g., a BUSY response, indicating that, after the permission of starting the function-pass procedure, the service request provided by the processing request node 600 is not accepted. Although the provision of service is stopped, by the server provision stopping module 11b making a response of not accepting the server request as a server, the processing request node 600, e.g., an external device, is clearly notified that the server is operating. During this time, in response to the permission of starting the function-pass procedure, the information receiving module 12c is provided with information from the first server process execution module 11 through the process-to-process communications. The information here is desired by the service providing module 12d for the provision of service. Also in response to the permission of starting the function-pass procedure, the information transmitting module 11f forwards information to the second server process execution module 12 through the process-to-process communications. The information here is information desired by the service providing module 11a for the provision of service.

After the completion of the information transmission by the information transmitting module 11f, in the second server process execution module 12, the service ending module 11c ends the provision of service by the service providing module 11a. After the completion of the information reception by the information receiving module 12c, in the first server process execution module 11, the service starting module 12e starts the provision of service by the service providing module 12d based on the received information.

With the procedure for software update to pass the server function from the first server process execution module 11 to the second server process execution module 12, the cluster system may reduce if not minimize reduction of operation efficiency.

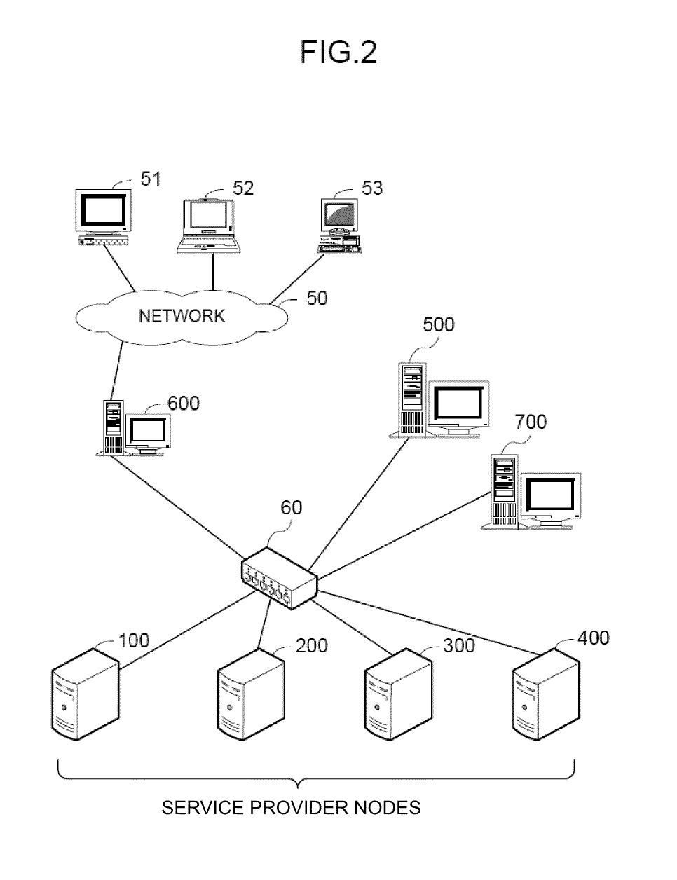

Next, the embodiment is described in detail. FIG. 2 is a diagram illustrating an exemplary configuration of the cluster system of the embodiment. In this embodiment, connection via a switch 60 is established among a plurality of service provider nodes 100, 200, 300, and 400, a monitoring node 500, the processing request node 600, and a management node 700.

The service provider nodes 100, 200, 300, and 400 are each a computer using an architecture called IA (Intel Architecture), for example. The service provider nodes 100, 200, 300, and 400 each have a function of executing data processing in accordance with a processing request based on application software. The data processing service function is referred to below as server. The server incorporated in each of the service provider nodes 100, 200, 300, and 400 is capable of transmitting heartbeats to the monitoring node 500 at regular intervals.

Note here that the transmission interval of the heartbeats may be arbitrarily changed. When the transmission interval of the heartbeats is changed, information indicating the new interval of the heartbeats is provided from the service provider nodes 100, 200, 300, and 400 to the monitoring node 500.

The monitoring node 500 controls the service provider nodes 100, 200, 300, and 400. For example, the monitoring node 500 knows which of the service provider nodes 100, 200, 300, and 400 are in normal operation by receiving the heartbeats provided respectively therefrom. That is, in accordance with the information provided respectively from the service provider nodes 100, 200, 300, and 400 indicating the transmission interval of heartbeats, the monitoring node 500 waits for the heartbeats at intervals varying among the service provider nodes 100, 200, 300, and 400. When there is any service provider node not providing the heartbeats at designated intervals, the monitoring node 500 determines that the service provider node is in failure.

The processing request node 600 is connected with a plurality of terminal devices 51, 52, and 53 over a network 50. The processing request node 600 acknowledges the storage location of data, each under the management of the service provider nodes 100, 200, 300, and 400. The processing request node 600 makes a data access to the service provider nodes 100, 200, 300, and 400 in response to requests from the terminal devices 51, 52, and 53.

The management node 700 is a computer for managing the system in its entirety. The management node 700 forwards, in response to an operation input by a manager, an update request to the service provider nodes 100, 200, 300, and 400 for update of server software, for example.

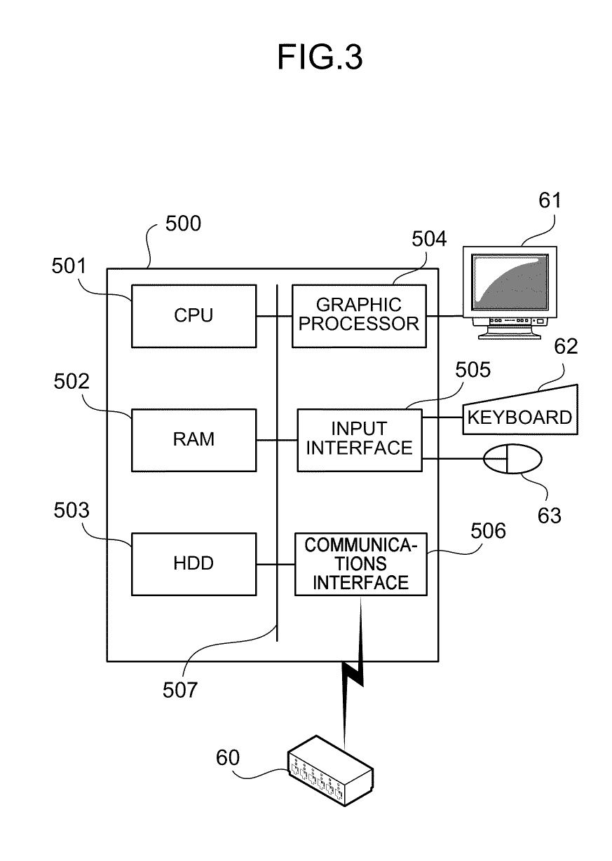

FIG. 3 is a diagram illustrating an exemplary hardware configuration of the monitoring node in this embodiment. The monitoring node 500 is under the control of a CPU (Central Processing Module) 501. The CPU 501 is connected, over a bus 507, with a RAM (Random Access Memory) 502, a hard disk drive (HDD) 503, a graphic processor 504, an input interface 505, and a communications interface 506.

The RAM 502 temporarily stores therein at least partially an OS (Operating System) program to be run by the CPU 501, and an application program for server execution. The RAM 502 stores therein various types of data for processing by the CPU 501. The HDD 503 stores therein the OS and application programs.

The graphic processor 504 is connected to a monitor 61. The graphic processor 504 displays images on the screen of the monitor 61 in accordance with a command from the CPU 501. The input interface 505 is connected with a keyboard 62 and a mouse 63. The input interface 505 forwards signals from the keyboard 62 and the mouse 63 to the CPU 501 over the bus 507.

The communications interface 506 is connected to the switch 60. The communications interface 506 performs data transmission and reception to and/or from other computers via the switch 60. With the hardware configuration, the processing functions of the embodiment may be implemented. Note here that FIG. 3 illustrates an exemplary hardware configuration of the monitoring node, and a similar hardware configuration may implement other components, e.g., the service provider nodes 100, 200, 300, and 400, the processing request node 600, the management node 700, and the terminal devices 51, 52, and 53.

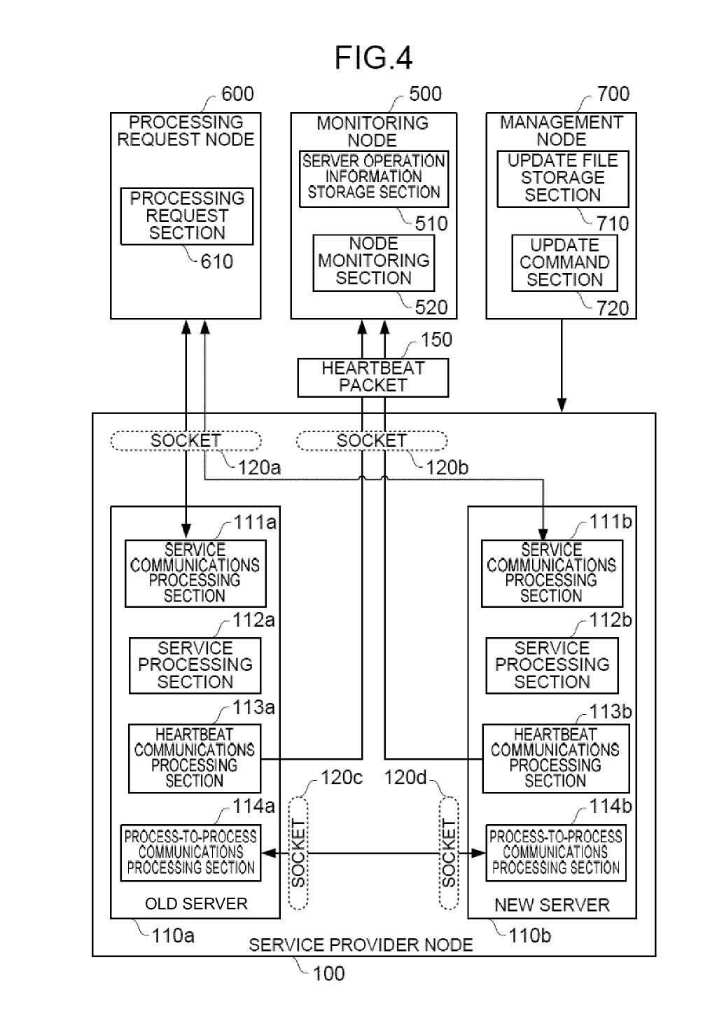

FIG. 4 is a function block diagram of a decentralized processing system. The service provider node 100 includes an old server 110a, and a new server 110b. The old and new servers 110a and 110b are each a processing function (process) for the provision of service, and are different in version, i.e., old and new versions.

The server function (service) provided by the service provider node 100 is implemented by the service provider node 100 running the server software. The function block diagram of FIG. 4 illustrates the state in which the two servers, i.e., the old and new servers 110a and 110b, are activated for update of the server software.

The servers 110a and 110b are respectively configured to include service communications processing sections 111a and 111b, service processing sections 112a and 112b, heartbeat communications processing sections 113a and 113b, and process-to-process communications processing sections 114a and 114b.

The service communications processing section 111a or 111b communicates with the processing request node 600 by creating a socket 120a, or if the socket 20a is already created, via the socket 120a. The service communications processing section 111a or 111b accepts a processing request from the processing request node 600, and asks the corresponding service processing section 112a or 112b to execute the service procedure requested. The service communications processing section 111a or 111b forwards, to the processing request node 600, the processing result provided by the corresponding service processing section 112a or 112b.

The service processing sections 112a and 112b respectively execute the service procedure requested to the service communications processing sections 111a and 111b, and forward the processing result as a response to the service communications processing sections 111a and 111b, respectively.

The heartbeat communications processing sections 113a and 113b each create a socket 120b, and forward a heartbeat packet 150 to the monitoring node 500 at regular intervals. Note here that the heartbeat communications processing sections 113a and 113b each provide information in the heartbeat packet 150. The information includes the transmission interval of the heartbeats, i.e., heartbeat interval information, whereby the monitoring node 500 is notified of the current transmission interval of the heartbeats. The transmission interval of the heartbeat packet 150 is defined in an initial state in advance, and may be changed in accordance with any conditions.

The process-to-process communications processing sections 114a and 114b perform process-to-process communications by creating sockets 120c and 120d, respectively. The process-to-process communications processing sections 114a and 114b each perform transmission and reception of data for switching from the old server 110a to the new server 110b through the process-to-process communications. When the transmission and reception of data is completed, the process-to-process communications processing sections 114a and 114b each switch the server function from the old server 110a to the new server 110b, thereby stopping operation of the old server 110a. In the state in which either the server 110a or 110b is ready for a response with respect to any device connected over the network, e.g., when the communications path is secure, the data is passed from the old server 110a to the new server 110b.

Note here that the functions of the components of FIG. 1, that is, the process-to-process communications establishing module 11d, the function-pass start permitting module 11e, and the information transmitting module 11f, are provided in the process-to-process communications processing section 114a, and the functions of the components, that is, the process-to-process communications establishing module 12a, the function-pass start requesting module 12b, and the information receiving module 12c, are provided in the process-to-process communications processing section 114b.

The service provider node 100 activates the new server 110b in accordance with a command, e.g., an activation command, from an update command section 720. The update command section 720 forwards, in response to an operation input by a manager, a request for software update to the service provider node 100. The server software of the new server 110b, e.g., an update program, is distributed from an update file storage section 710 to the service provider node 100.

Herein, for transmission of the software update request, alternatively, the update command section 720 may acquire the update program from the update file storage section 710 for transmission to the service provider node 100 together with the software update request, or may transmit the update program in advance before the software update request. Still alternatively, the update program may be read by the service provider node 100 via a portable recording medium, or may be stored in advance in an HDD in the service provider node 100 as a program to be updated.

The monitoring node 500 includes a server operation information storage section 510 and a node monitoring section 520. The server operation information storage section 510 stores therein server operation information, which is a data table for management to see whether the servers equipped in the service provider nodes 100, 200, 300, and 400 are each in operation or not. The server operation information storage section 510 is a part of the storage area of the RAM 502, for example.

The processing request node 600 includes a processing request section 610. The processing request section 610 forwards, over the network 50, the processing requests from the terminal devices 51 to 53 to any of the corresponding service provider nodes 100, 200, 300, and 400. For example, the processing request node 600 acquires information about a load from each of the service provider nodes 100, 200, 300, and 400, and forwards a processing request to any of the service provider nodes with a lighter load. When a response from the service provider node to which the processing request is directed is received, the processing request section 610 forwards the response to the terminal device from which the processing request is provided.

The management node 700 includes the update file storage section 710 and the update command section 720. The update file storage section 710 stores therein a program file (update file) for use to update the servers 110. For example, the update file storage section 710 is a part of the storage area of the hard disk drive of the management node 700.

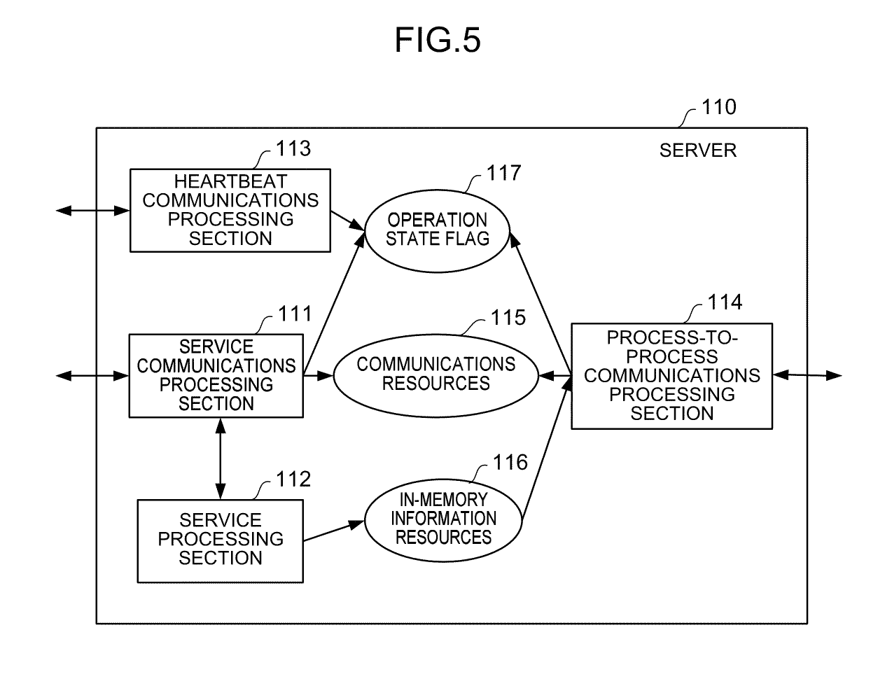

FIG. 5 is a function block diagram of the server. The old and new servers 110a and 110b share similar function blocks. The server 110 is configured to include function blocks of a service communications processing section 111, a service processing section 112, a heartbeat communications processing section 113, and a process-to-process communications processing section 114. The server 110 is also configured to include communications resources 115, in-memory information resources 116, and an operation state flag 117.

The communications resources 115 include a group of sockets, i.e., sockets 120a, 120b, 120c, 120d, and others. The sockets are each a function to be provided by the OS by any virtual interface for communications. The socket 120a is created for each type of service. Accordingly, for processing a plurality of types of services, a plurality of sockets 120a may be created. The socket 120b is repeatedly created and released every time a heartbeat packet is transmitted so as not to overly increase the communications resources 115 of the node monitoring section 520 of the monitoring node 500 even if the number of the service provider nodes is increased in the cluster system. The sockets 120c and 120d are created for use with the process-to-process communications between the old and new servers.

The in-memory information resources section 116 is located in a memory area allocated to the process of running the server software, and includes various types of information, e.g., information to provide various types of services, information to perform heartbeat communications, and management information about the server software.

The operation state flag 117 indicates the operation state of the server 110. The operation state includes a “normal” state in which the provision of service is possible, a “pause” state in which the provision of service is temporarily stopped, and an “end” state in which the provision of service is ended.

The service communications processing section 111 communicates with the processing request node 600 via the socket 120a, e.g., performs service communications. The service communications processing section 111 accepts a processing request provided by the processing request node 600. At this time, by referring to the operation state flag 117, when the flag indicates the “normal” state, the service communications processing section 111 asks the service processing section 112 to execute the requested service procedure. The processing result provided by the service processing section 112 is then forwarded as a response to the processing request node 600. Also by referring to the operation state flag 117, when the flag indicates the “pause” state, the service communications processing section 111 issues a BUSY response to the processing request node 600 without making a request to the service processing section 112 to execute the requested service procedure.

The service processing section 112 executes the service procedure asked by the service communications processing section 111, and forwards the processing result as a response thereto. The heartbeat communications processing section 113 transmits, via the socket 120b, the heartbeat packet 150 to the monitoring node 500 at regular intervals, e.g., performs heartbeat communications. Note here that the heartbeat communications processing section 113 provides information in the heartbeat packet 150 about the transmission interval of the heartbeats, thereby notifying the monitoring node 500 of the current transmission interval of the heartbeats. The transmission interval of the heartbeat packet 150 is defined in an initial state in advance, and may be changed in accordance with any conditions.

The process-to-process communications processing section 114 performs the process-to-process communications by creating the socket 120c or 120d. Through the process-to-process communications, the process-to-process communications processing section 114 performs transmission and reception of data for switching from the old server 110a to the new server 110b. After the completion of the transmission and reception of data, the process-to-process communications processing section 114 switches the server function from the old server 110a to the new server 110b, thereby stopping operation of the old server 110a. In the state in which either the server 110a or 110b is ready for communication with respect to any device connected over the network, e.g., the communications path is secure, the server function is passed from the old server 110a to the new server 110b.

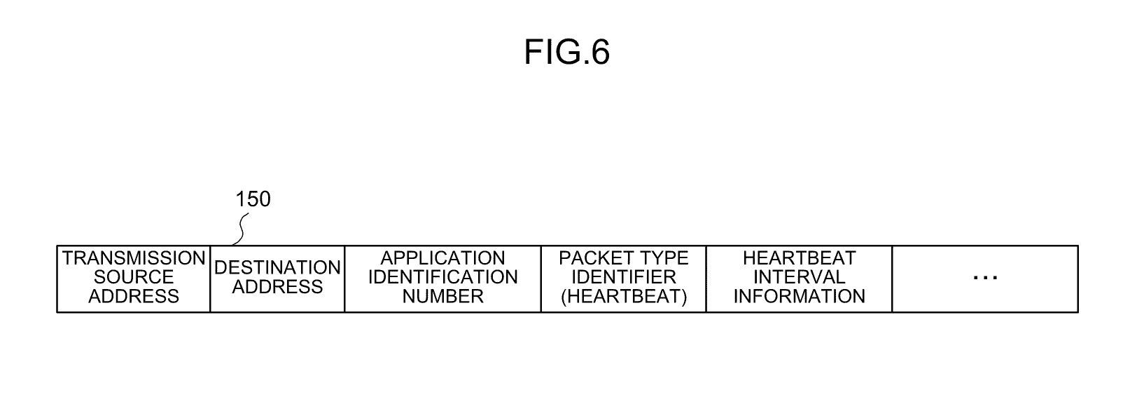

Note here that the process-to-process communications is surely not restricted to use the socket as above, and may use file mapping or a pipe, for example. FIG. 6 is a diagram illustrating an exemplary data configuration of the heartbeat packet. The heartbeat packet 150 is provided with fields of “transmission source address”, “destination address”, “application identification number”, “packet type identifier”, “heartbeat interval information”, and the like.

The field of “transmission source address” indicates an address set to uniquely identify, on the network, from which service provider node the heartbeat packet 150 is transmitted. As an example, the transmission source address may be the IP (Internet Protocol) address of the service provider node.

The field of “destination address” indicates an address set to uniquely identify, on the network, to which monitoring node 500 the heartbeat packet 150 is to be directed. As an example, the destination address may be the IP address of the monitoring node 500.

Note here that the fields of “transmission source address” and “destination address” are included in header information of the heartbeat packet 150. The field of “application identification number” indicates an identification number set for the monitoring node 500 to uniquely identify the type of the server 110 providing the heartbeats. This identification number may be also a port number for communications use by the server 110, for example.

The field of “packet type identifier” indicates an identifier representing that the heartbeat packet 150 is a packet indicating the heartbeats. The field of “heartbeat interval information” indicates a value representing a time in seconds for the transmission interval of the heartbeats.

When receiving the heartbeat packet 150, based on the heartbeats, the monitoring node 500 enters the operation state of each of the servers into a server operation information table in the server operation information storage section 510.

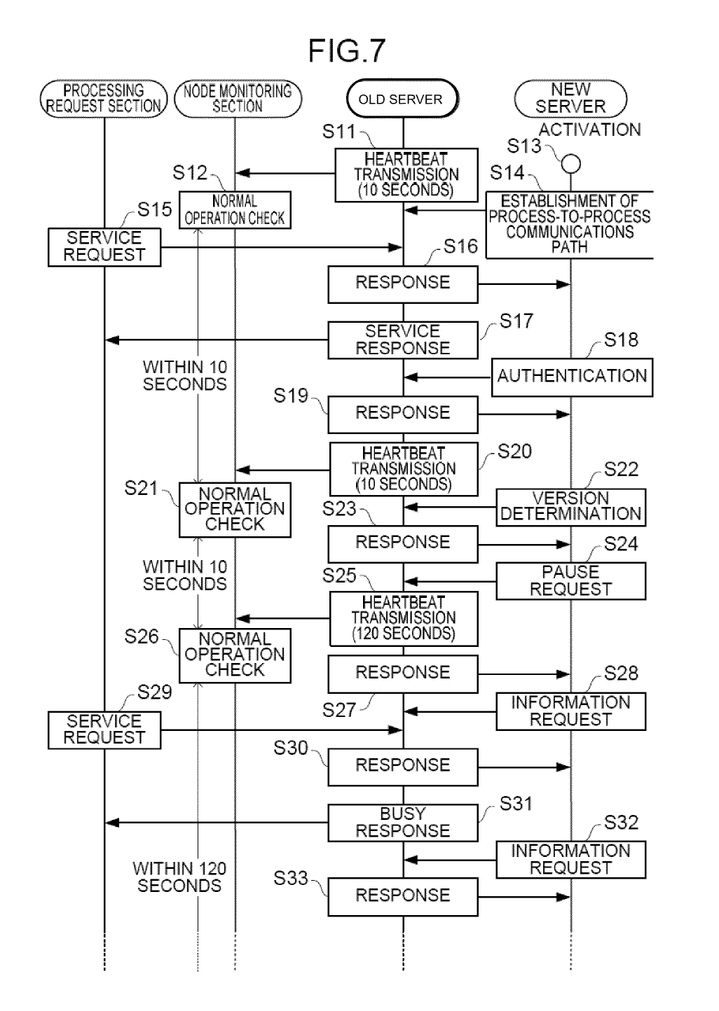

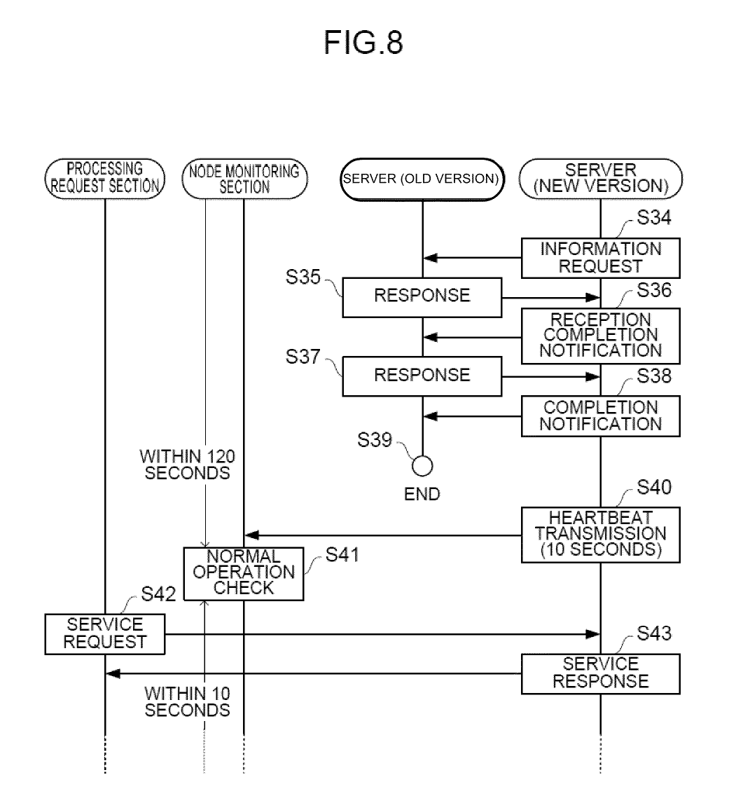

Next, the software update procedure is described in detail. FIGS. 7 and 8 are each a sequence diagram of the software update procedure. The procedure operations of FIGS. 7 and 8 are described below in order of operation number.

Operation S11: While the old server 110a is being activated, the heartbeat communications processing section 113a in the old server 110a of the service provider node 100 transmits the heartbeat packet 150 at the heartbeat transmission interval of a default value set in advance. The heartbeat transmission interval herein is exemplified as being 10 seconds.

Operation S12: The node monitoring section 520 of the monitoring node 500 acquires the heartbeat packet 150 and checks whether the old server 110a is operating normally or not. The node monitoring section 520 then sets the current time in the server operation information storage section 510, e.g., in the field for the heartbeat acquisition time corresponding to the old server 110a.

Operation S13: The service provider node 100 activates the new server 110b. The new server 110b may be activated based on a command from the update command section 720 of the management node 700. Herein, the new server 110b may be also activated through remote operation or other methods by a timer or an operator.

Operation S14: The process-to-process communications processing section 114b of the new server 110b creates the socket 120d, thereby establishing a process-to-process communications path with the socket 120c created by the old server 110a. Since the new server 110b already knows the communication partner information, the old server 110a creates the socket 120c for indicating its own communication partner information and then waits for the connection from the new server 110b to establish the process-to-process communications path. The process-to-process communications processing section 114b thus communicates with the process-to-process communications processing section 114a.

Operation S15: The processing request section 610 of the processing request node 600 transmits a service request, e.g., a processing request, issued by any of the terminal devices to the service provider node 100. At this time, the number of a port established in the server 110a is designated as a port number of the transmission destination for the service request. The service communications processing section 111a in the server 110a of the service provider node 100 is then provided with the service request from the processing request node 600.

Operation S16: The process-to-process communications processing section 114a of the old server 110a makes a response to a request from the new server 110b, e.g., a request for establishing the process-to-process communications path. Note here that the response corresponding to the request for establishing the process-to-process communications path is not made after waiting for the service request for operation S15. The response is made with no delay and indicates that the service request of operation S15 occurs like an event.

Operation S17: In response to the service request of operation S15, the service communications processing section 111a of the old server 110a checks first that the operation state flag 117 indicates the “normal” state, and then asks the service processing section 112a to do the provided service request. The service communications processing section 111a then transmits, to the processing request section 610, the service response, i.e., the processing result, provided by the service processing section 112a. After receiving the response, the processing request section 610 forwards the processing result found in the response to the terminal device.

Operation S18: After receiving the response that the process-to-process communications path is established, the process-to-process communications processing section 114b of the new server 110b makes a request for authentication to the old server 110a. For making the request for authentication, the process-to-process communications processing section 114b forwards any specific information with which the appropriateness of the new server 110b may be checked. The information may include text string, number sequence, specific code, and other information.

Operation S19: The process-to-process communications processing section 114a of the old server 110a makes a response to the authentication request from the new server 110b. The process-to-process communications processing section 114a checks the specific information provided at the time of the authentication request to verify the appropriateness, e.g., whether the new server 110b is appropriate for the old server 110a to pass the server function.

Operation S20: The heartbeat communications processing section 113a of the old server 110a transmits the heartbeat packet 150 at the heartbeat transmission interval.

Operation S21: The node monitoring section 520 acquires the heartbeat packet 150 to check whether the servers 110 are operating normally or not. The node monitoring section 520 updates the information corresponding to the servers 110 in the server operation information storage section 510.

Operation S22: After receiving the response corresponding to the authentication, the process-to-process communications processing section 114b of the new server 110b asks the old server 110a to make a version determination. For making the request for version determination, the old server 110a transmits version information for use to check whether the version update is allowed or not. The version information may include additional information about the version (the number of the version) of the new server 110b, a number sequence to compare which version is the latest, and the restrictions on version update, for example.

Operation S23: The process-to-process communications processing section 114a of the old server 110a makes a response corresponding to the version determination request from the new server 110b, in other words, verifies the version information provided with the version determination request to determine whether the version update is allowed or not, and forwards back the result.

Operation S24: When the provided response indicates that the version update is allowed, the process-to-process communications processing section 114b of the new server 110b asks the old server 110a to delay the server function.

Operation S25: In response to the request from the new server 110b to delay the service function, the heartbeat communications processing section 113a of the old server 110a transmits the heartbeat packet 150 at the heartbeat transmission interval, which is a time value set as being sufficient for a software update. Herein, the heartbeat transmission interval is assumed as being set to 120 seconds. This is to provide enough time for preparing the passing of the server function from the old server 110a to the new server 110b, and to notify the node monitoring section 520 that the old server 110a is being activated. Upon reception of the pause request, the old server 110a accordingly delays the provision of service.

Operation S26: The node monitoring section 520 acquires the heartbeat packet 150 to check whether the servers 110 are operating normally or not. The node monitoring section 520 also updates the information in the server operation information storage section 510 corresponding to the servers 110. At this time, the heartbeat transmission interval of 120 seconds is set in the field of the heartbeat interval information in the server operation information storage section 510 corresponding to the servers 110.

Operation S27: The process-to-process communications processing section 114a of the old server 110a makes a response corresponding to the pause request from the new server 110b. The response corresponding to the pause request is made after the provision of service is temporarily stopped. When the service request is provided earlier than the pause request, the service response is made first before the provision of service is temporarily stopped. When the service request is accepted later than the pause request (operation S29), the process-to-process communications processing section 114a makes a BUSY response, e.g., a response of insufficient resources (operation S31). By making the BUSY response, a notification is made that the server function is not stopped, thereby not requiring troubleshooting that is necessary when the server is stopped in operation. Upon reception of the BUSY response, the processing request section 610 transmits again the service request after the lapse of a specific time, e.g., a random time.

Operation S28: After receiving the response corresponding to the pause request, the process-to-process communications processing section 114b of the new server 110b asks for information to pass the server function to the old server 110a. The information includes, for example, information to provide various types of service, information to perform heartbeat communications, management information about the server software and other various types of information. The information is requested repeatedly for a desired number of times in a specific unit, e.g., data item, data amount (operations S32 and S34).

Operation S30: The process-to-process communications processing section 114a of the old server 110a forwards, as a response, the information asked by the new server 110b. The response is made at every request (operations S33 and S35).

Operation S36: When determining that all the desired information is acquired based on the response about the acquisition of information, the process-to-process communications processing section 114b of the new server 110b indicates the completion of reception by issuing a reception completion notification.

Operation S37: The process-to-process communications processing section 114a of the old server 110a makes a response of YES to the reception completion notification.

Operation S38: When receiving the response corresponding to the reception completion notification, the process-to-process communications processing section 114b of the new server 110b transmits a completion notification indicating that the procedure is now completed for passing the server function. Thereafter, the new server 110b is provided with the server function from the old server 110a, and offers the server function as the server 110. The service communications processing section 111b in the new server 110b of the service provider node 100 is provided with a service request from the processing request node 600.

Operation S39: The process-to-process communications processing section 114a of the old server 110a is provided with a completion notification. In response to the completion notification, the process of offering the server function of the old server 110a is ended. The function-pass procedure for the server function is completed by three levels of handshaking and the reliability of the passing of the server function is improved.

Operation S40: In response to the completion of the function-pass procedure for the server function, the heartbeat communications processing section 113b of the new server 110b transmits the heartbeat packet 150 at the heartbeat transmission interval of a default value. At this time, the heartbeat transmission interval is assumed as being 10 seconds.

Operation S41: The node monitoring section 520 acquires the heartbeat packet 150 to check whether the servers 110 are operating normally or not. The node monitoring section 520 also updates information in the server operation information storage section 510 corresponding to the servers 110. At this time, the heartbeat transmission interval of 10 seconds is set in the field of the heartbeat interval information in the server operation information storage section 510 corresponding to the servers 110.

Operation S42: The processing request section 610 of the processing request node 600 transmits the service request issued by the terminal device to the service provider node 100. The service request is received by the service communications processing section 111b in the new server 110b in the service provider node 100.

Operation S43: In response to the service request of operation S42, the service communications processing section 111b of the new server 110b checks whether the operation state flag 117 indicates the “normal” state or not. After the completion of the check, the service communications processing section 111b asks the service processing section 112b to do the provided service request. The service communications processing section 111b then forwards the service response, in other words the processing result, provided by the service processing section 112b to the processing request section 610. After receiving the response, the processing request section 610 forwards the processing result found in the response to the terminal device.

With the process-to-process communications, any information for the passing of server function is transmitted from the old server 110a to the new server 110b. Also with the BUSY response during the function-pass procedure for the server function, the processing request section 610 is notified that the server function is not stopped. The insufficiency of resources, e.g., communications resources, memory resources, and CPU time, is expected to be solved after a wait of a specific length of time unlike a hardware or software failure in the service provider node 100. Accordingly, after receiving the response of the insufficient resources, the processing request section 610 makes another request for processing. When the insufficiency of resources is not resolved even if the request is made many times, the processing request section 610 generally executes an error procedure. The BUSY response during the passing of the server function serves to prevent the execution of the error procedure with respect to an error that does not actually occur. What is more, since error determination may be improved in accuracy, any margin for determination conditions to reduce or avoid wrong error determination may be reduced. This is a contributing factor for faster error determination.

Also the node monitoring section 520 is notified that the server function is not stopped by changing the transmission interval of the heartbeat communications, and by passing the server function from the transmission source, e.g., the heartbeat communications processing section 113a, to the heartbeat communications processing section 113b, thereby preventing any unnecessary troubleshooting.

Note here that the old server 110a may be run by any existing software and is a target server for software update. The old server 110a is actually providing the service in the service provider node 100. The server 110b may be run by a new version of software and is provided with the server function from any existing server in the service provider node 100.

Herein, the new version of software is a result of function enhancing, updating, and/or correcting any existing software, for example, and the resulting software is managed by the number of the version. The software managed by the number of the version has a function of transferring any information for passing the server function from the old version to the new version, in other words, passing from the old to the new process. Information transfer by the process-to-process communications allows an access to any of the resources, e.g., communications resources and memory resources.

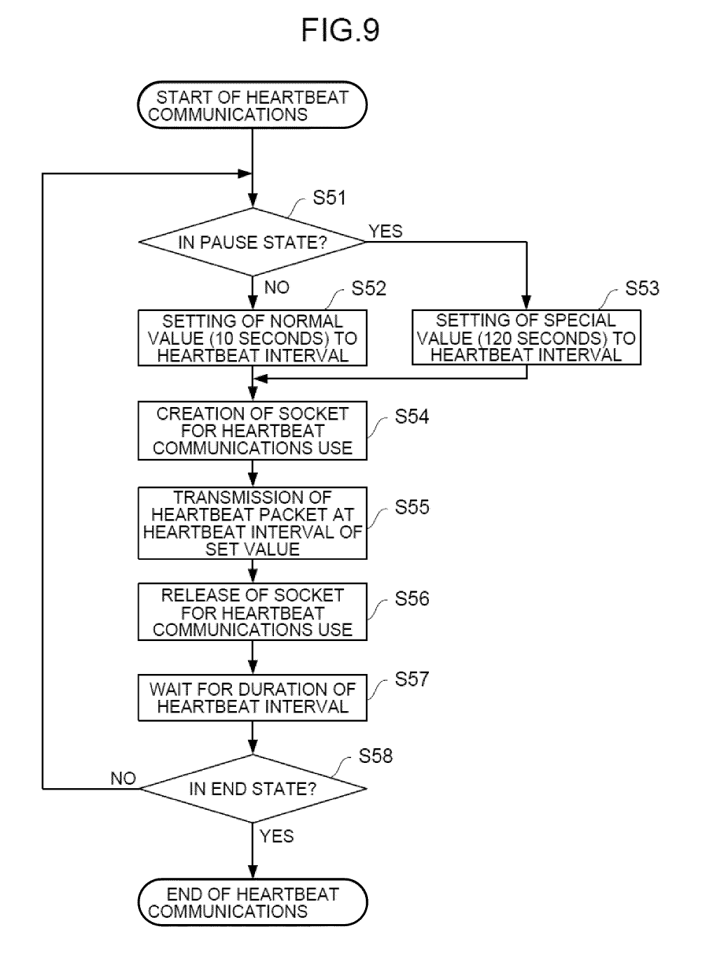

The heartbeat communications procedure is described next in detail. FIG. 9 is a flowchart of the heartbeat communications procedure. The operations of FIG. 9 are described below in order of operation number. Herein, this procedure is executed by the heartbeat communications processing section 113.

Operation S51: The operation state flag 117 is referred to for determining whether the flag indicates a “pause” state or not.

Operation S52: When the state is not “pause”, in other words when the state is “normal”, the heartbeat interval is set with a normal value (default value) of 10 seconds.

Operation S53: When the operation state flag 117 indicates the “pause” state, the heartbeat interval is set with a special value of 120 seconds.

Operation S54: The socket 120b is created for use with the heartbeat communications.

Operation S55: The socket 120b is created for every transmission of a heartbeat packet, and the heartbeat packet is transmitted at the heartbeat interval of a set value.

Operation S56: After the transmission of the heartbeat packet, the socket 120b for use with the heartbeat communications is released. This is not to excessively consume the communications resources of the node monitoring section 520 by one-time communications to be performed at a specific timing.

Operation S57: The procedure waits for the duration of the heartbeat interval.

Operation S58: The operation state flag 117 is referred to for determining whether the flag indicates an “end” state or not. When the state is not “end”, the procedure goes to operation S51, and when the state is “end”, this is the end of the heartbeat communications procedure.

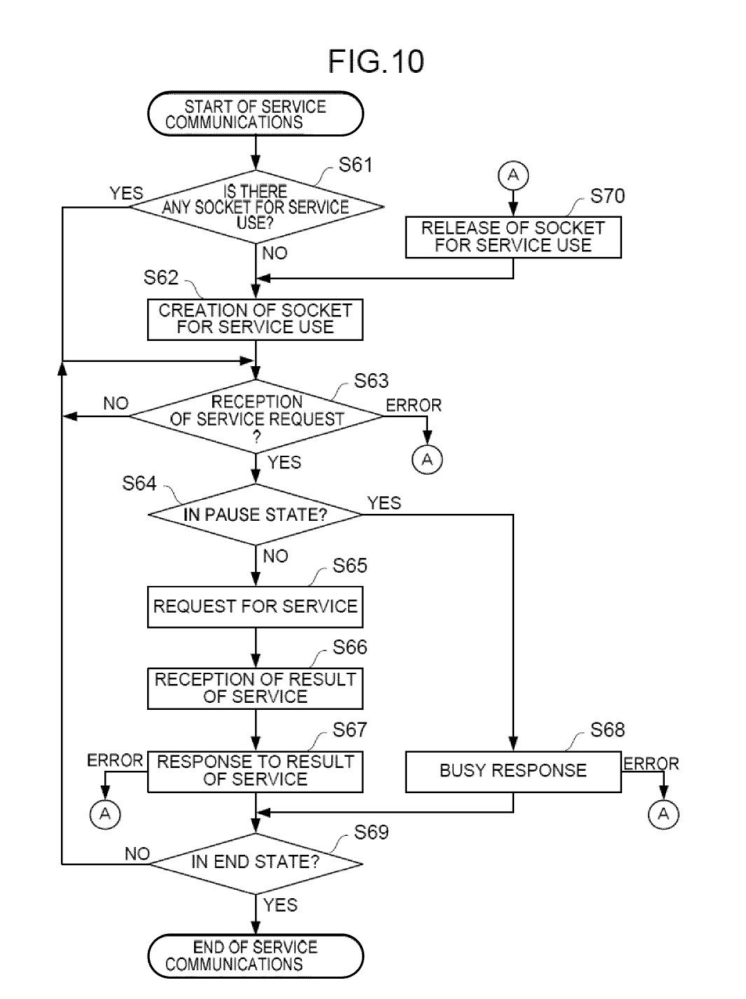

The service communications procedure is described next in detail. FIG. 10 is a flowchart of the service communications procedure. The operations of FIG. 10 are described below in order of operation number. Herein, this procedure is executed by the service communications processing section 111.

Operation S61: A determination is made whether a socket 120a is available for service use. When the socket 120a is available, the procedure goes to operation S63.

Operation S62: When a socket 120a is not available, the socket 120a for service use is created. The socket 120a for service use is created for every type of service. The service communications processing section 111 communicates with the processing request section 610 via the socket 120a.

Operation S63: A determination is made as to whether a service request is received or not. When the service request is already received, the procedure goes to operation S64. When the service request is not yet received, the service request waits for reception. When any normal request cannot be received due to faulty communications, for example, it is determined that there is an error. In such a case, the socket 120a for service use is released first (operation S70), and then another service socket 120a is created again for service use (operation S62).

Operation S64: The operation state flag 117 is referred to for determining whether the flag indicates the “pause” state or not. When the state is not “pause”, in other words when the state is “normal”, the procedure goes to operation S65. When the state is “pause”, the procedure goes to operation S68.

Operation S65: Based on the provided service request, a request is made to the service processing section 112 about the requested service.

Operation S66: The result of the service with respect to the service request asked for the service processing section 112 is provided from the service processing section 112.

Operation S67: The result of the service provided by the service processing section 112 is forwarded as a response to the processing request section 610. When the response cannot be transmitted normally due to faulty communications, for example, it is determined that there is an error, and the procedure goes to operation S70.

Operation S68: Because a response cannot be made corresponding to the provided service request, a BUSY response is made to the processing request section 610. When the BUSY response cannot be transmitted normally due to faulty communications, for example, it is determined that there is an error, and the procedure goes to operation S70.

Operation S69: The operation state flag 117 is referred to for determining whether the flag indicates the “end” state or not. When the state is not “end”, the procedure goes to operation S61, and when the state is “end”, this is the end of the service communications procedure.

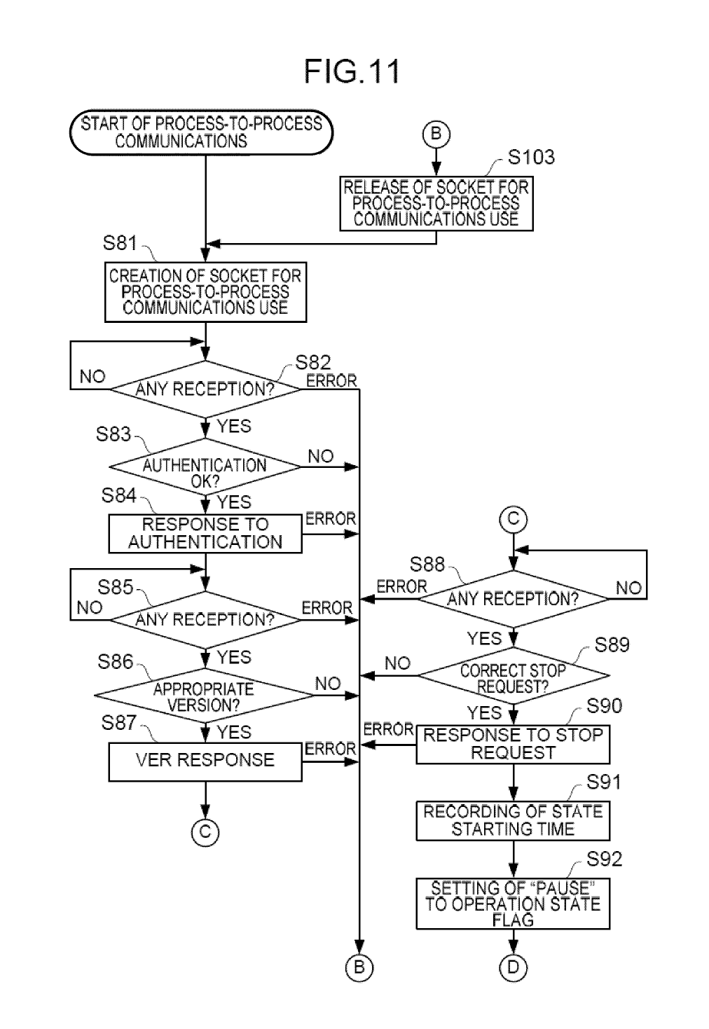

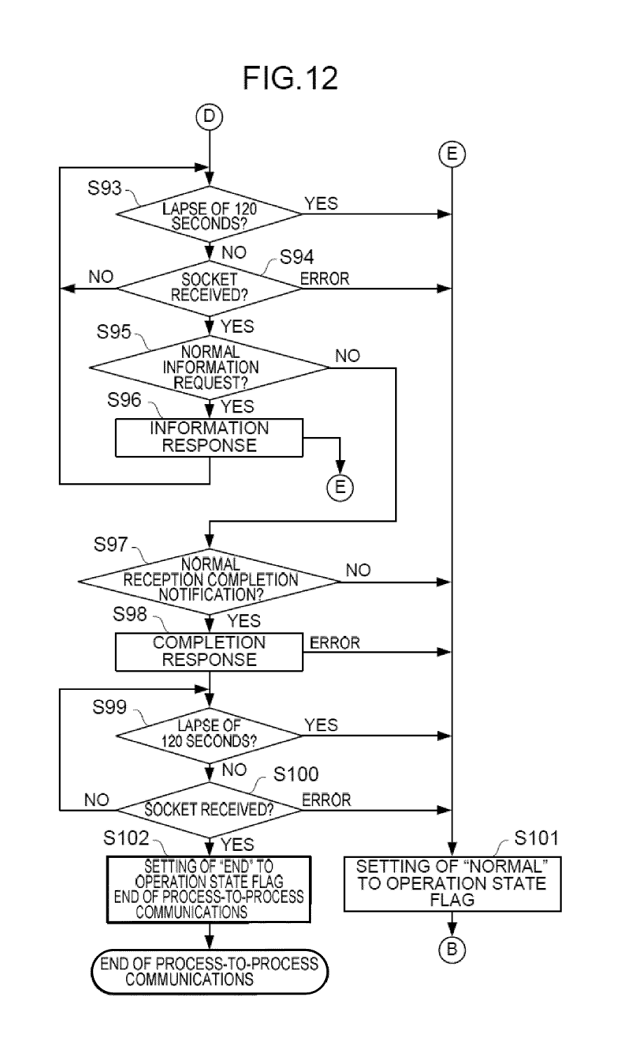

The process-to-process communications procedure is described next in detail. FIGS. 11 and 12 describe a flowchart of the process-to-process communications procedure. The operations of FIGS. 11 and 12 are described in order of operation number. Herein, this procedure is executed by the process-to-process communications processing section 114.

Operation S81: The socket 120c is created for use with the process-to-process communications.

Operation S82: The process-to-process communications processing section 114 communicates with another process-to-process communications processing section 114 of the operating server by a new and updated software. Therefore, the existing process-to-process communications processing section 114 (114a) is in a standby state to wait for a connection request from the new process-to-process communications processing section 114 (114b) with an open process-to-process communications path. The existing process-to-process communications processing section 114a establishes the process-to-process communications path as a response to the connection request from the new process-to-process communications processing section 114b. The existing and new process-to-process communications processing sections 114a and 114b perform information exchange over the established process-to-process communications path. When an authentication request is received, the procedure goes to operation S83. When no authentication request is received, the authentication request waits for reception. When the authentication request cannot be received due to faulty communications, for example, it is determined that there is an error. In such a case, the socket 120c for use with the process-to-process communications is released first (operation S103), and then another socket 120c is created again for the use with the process-to-process communications (operation S81).

Operation S83: The existing process-to-process communications processing section 114a checks the correctness of authentication data provided together with the authentication request from the new process-to-process communications processing section 114b. The correctness check may be made by a comparison between known authentication codes of the existing and new process-to-process communications processing sections 114a and 114b, for example. For the correctness check, not only the comparison between the authentication codes but also a comparison between the results of any specific computation with respect to the authentication codes may be used. The authentication code may include a text string, a number sequence, any specific code, and/or other information. The specific computation may include an encrypt or decrypt function, a hash function, and/or other functions. After the completion of the authentication, the procedure goes to operation S84. When the authentication is not performed, it is determined that there is an error, and the procedure goes to operation S103.

Operation S84: A response is made to notify the completion of authentication. When the response cannot be transmitted normally due to faulty communications, for example, it is determined that there is an error, and the procedure goes to operation S103.

Operation S85: When the response of authentication is received, the new process-to-process communications processing section 114b forwards a notification about the version of the new software. When the version notification is received, the procedure goes to operation S86. When no version notification is received, the version notification waits for reception. When the version notification cannot be received due to faulty communications, for example, it is determined that there is an error, and the procedure goes to operation S103.

Operation S86: The existing process-to-process communications processing section 114a refers to the version notification provided by the new process-to-process communications processing section 114b to check the appropriateness of software update. For example, the process-to-process communications processing section 114a makes a comparison of version numbers between the new software, e.g., software for operating the new server 110b, and the existing software, e.g., software for operating the old server 110a, and determines whether a version update is possible or not. When the determination result indicates that the version update is possible, the procedure goes to operation S87, and when the determination result indicates that the version update is not possible, it is determined that there is an error, and the procedure goes to operation S103.

Operation S87: When the determination result indicates that the version update is possible, a response (VER response) is made to notify that the version update is possible. When the response cannot be transmitted normally due to faulty communications, for example, it is determined that there is an error, and the procedure goes to operation S103.

Operation S88: When the VER response is received, the new process-to-process communications processing section 114b forwards a request for stopping the old server 110a. When the stop request is received, the procedure goes to operation S89. When no stop request is received, the stop request waits for reception. When the stop request cannot be received due to faulty communications, for example, it is determined that there is an error, and the procedure goes to operation S103.

Operation S89: The existing process-to-process communications processing section 114a checks the appropriateness of the stop request provided by the new process-to-process communications processing section 114b. When the determination result indicates that the stop request is appropriate, the procedure goes to operation S90, and when the determination result indicates that the stop request is not appropriate, it is determined that there is an error, and the procedure goes to operation S103.

Operation S90: In accordance with the stop request, a response is made to notify that the server function is temporarily stopped, e.g., a stop request response is made. When the response cannot be transmitted normally due to faulty communications, for example, it is determined that there is an error, and the procedure goes to operation S103.

Operation S91: For monitoring the time of delaying the server function, the starting time of the “pause” state is recorded in a specific storage area.

Operation S92: The operation state flag 117 is set to indicate the “pause” state. Note here that, by referring to the “pause” state of the operation state flag 117, the heartbeat communications processing section 113a sets the heartbeat interval with a special value of 120 seconds.

Operation S93: A determination is made as to whether the lapse of time exceeds 120 seconds (the special value of time set to the heartbeat interval) from the starting time recorded in operation S91. When the lapse of time exceeds 120 seconds, the passing of server function is cancelled and the procedure goes to operation S101. When the lapse of time does not exceed 120 seconds, the procedure goes to operation S94.

Operation S94: After receiving the response corresponding to the stop request, the new process-to-process communications processing section 114b forwards a request for information for the new server 110b to receive the server function from the old server 110a. When the information request is received, the procedure goes to operation S95. When no information request is received, the information request waits for reception. When the information request cannot be received due to faulty communications, for example, it is determined that there is an error, and the procedure goes to operation S101.

Operation S95: The existing process-to-process communications processing section 114a checks the appropriateness of the information request provided by the new process-to-process communications processing section 114b. When the determination result indicates that the information request is appropriate, the procedure goes to operation S96, and when the determination result indicates that the information request is not appropriate, e.g., when the reception completion notification is received, or when there is an error, the procedure goes to operation S97.

Operation S96: In accordance with the information request, information corresponding to the new process-to-process communications processing section 114b is reported (information response).

Operation S97: Reception details determined not to be an appropriate information request are checked to see if they are appropriate as a reception completion notification. When the reception details are determined to be appropriate as a reception completion notification, the procedure goes to operation S98. When the reception details are determined not to be appropriate as a reception completion notification, it is determined that there is an error, and the procedure goes to operation S101.

Operation S98: A response is made to notify that the reception completion notification is received (completion response), and the procedure goes to operation S99 to prepare for another reception completion notification. When the reception completion notification is determined as not being appropriate, it is determined that there is an error, and the procedure goes to operation S101.

Operation S99: A determination is made as to whether the lapse of time exceeds 120 seconds from the starting time recorded in operation S91. When the lapse of time exceeds 120 seconds, the passing of the server function is cancelled and the procedure goes to operation S101. When the lapse of time does not exceed 120 seconds, the procedure goes to operation S100.

Operation S100: After receiving the response of completion, the new process-to-process communications processing section 114b forwards a notification that the completion response is provided. When the completion notification is received, the procedure goes to operation S102. When no completion notification is received, the completion notification waits for reception. When the completion notification cannot be received due to faulty communications, for example, it is determined that there is an error, and the procedure goes to operation S101.

Operation S101: The operation state flag 117 is set to indicate the “normal” state. Thereafter, the socket 120c for use with the process-to-process communications is released first (operation S103), and then another socket 120c is created again for use with the process-to-process communications (operation S81).

Operation S102: The completion notification being provided by the new process-to-process communications processing section 114b means that the passing of the server function to the new server 110b is now completed, and thus the operation state flag 117 is set to indicate the “end” state. This is the end of the process-to-process communications procedure. In response thereto, the old server 110a ends the process of providing the server function.

Alternatively, the “end” state may be the “standby” state in which, after the socket 120a for service use is released, another service request will not be accepted, and the process will be on standby until the end. If this is the case, the process may be ended in response to a command from the update command section 720 of the management node 700, or in response to a remote operation by a timer or an operator, for example.

The old server 110a may be ready for a possible failure of the passing of the service function, and when the passing of the server function is successfully completed, may stop the server function and entrust the service function to the server 110b.

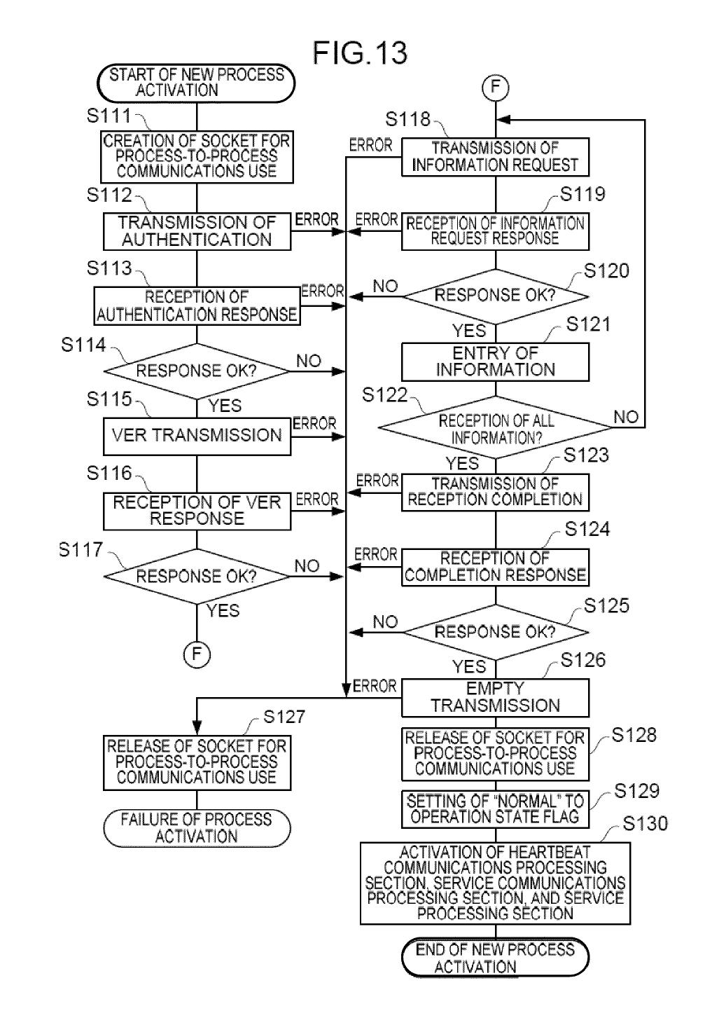

Described next in detail is a new process activation procedure. FIG. 13 is a flowchart of the new process activation procedure. The operations of FIG. 13 are described below in order of operation number. Herein, this procedure is executed by the process-to-process communications processing section 114 when any new process is activated.

Operation S111: The socket 120d is created for use with the process-to-process communications. The process-to-process communications processing section 114 communicates with another process-to-process communications processing section 114 of the operating server by any existing software which is a target for software update. Therefore, the new process-to-process communications processing section 114 (114b) asks the existing process-to-process communications processing section 114 (114a) to establish a process-to-process communications path. The existing process-to-process communications processing section 114a is continuously in the standby state to wait for a connection request with an open process-to-process communications path. Note here that the information about the socket 120c created by the existing process-to-process communications processing section 114a is known by the new existing process-to-process communications processing section 114b.

Operation S112: An authentication request is made to the existing process-to-process communications processing section 114a. At the same time, an authentication code is transmitted for authentication use. When the authentication request cannot be transmitted normally due to faulty communications, for example, the procedure goes to operation S127.

Operation S113: The existing process-to-process communications processing section 114a provided with the authentication request responsively forwards an authentication response. This authentication response is then received. When the authentication response cannot be received due to faulty communications, for example, it is determined that there is an error, and the procedure goes to operation S127.

Operation S114: The authentication response is checked to see whether the authentication is completed or not. When the check result indicates that the authentication is completed, the procedure goes to operation S115. When the check result indicates that the authentication is not yet completed, it is determined that there is an error, and the procedure goes to operation S127.

Operation S115: The existing process-to-process communications processing section 114a is notified of the version number of the new software. When the version notification cannot be transmitted normally due to faulty communications, for example, it is determined that there is an error i, and the procedure goes to operation S127.

Operation S116: The existing process-to-process communications processing section 114a provided with the version notification forwards a version response. This version response is then received. When the version response cannot be received due to faulty communications, for example, it is determined that there is an error, and the procedure goes to operation S127.

Operation S117: The version response is checked to see whether a version update is possible or not. When the check result indicates that the version update is possible, the procedure goes to operation S118. When the check result indicates that the version update is not possible (not allowed), it is determined that there is an error, and the procedure goes to operation S127.

Operation S118: An information request is transmitted to the existing process-to-process communications processing section 114a. When the information request cannot be transmitted normally due to faulty communications, for example, it is determined that there is an error, and the procedure goes to operation S127.

Operation S119: The existing process-to-process communications processing section 114a provided with the information request forwards information corresponding to the information request. This information reception response is then received. When the information request response cannot be received due to faulty communications, for example, it is determined that there is an error, and the procedure goes to operation S127.

Operation S120: A determination is made as to whether the received information request response is appropriate or not. When the information request response is determined as being appropriate, the procedure goes to operation S121. When the information request response is determined as not being appropriate, it is determined that there is an error, and the procedure goes to operation S127. The appropriateness of the information request response may be determined as to whether the details thereof meet the request or not, e.g., in terms of data format, the number of data, data size, and/or data range.

Operation S121: Based on the information request response, information is entered into the operation state flag 117, the communications resources section 115, and in-memory information resources section 116.

Operation S122: A determination is made as to whether any information for the passing of the server function is completely received or not. When the information is not yet completely received, the procedure goes to operation S118, and until the information is completely received, a request for the information is made continuously. When the information is completely received, the procedure goes to operation S123.

Operation S123: A reception completion notification is transmitted to the existing process-to-process communications processing section 114a. When the reception completion notification cannot be transmitted normally due to faulty communications, for example, it is determined that there is an error, and the procedure goes to operation S127.

Operation S124: The existing process-to-process communications processing section 114a provided with the reception completion notification forwards a completion response. This completion response is then received. This completion notification indicates that the passing of the server function is now successfully completed. When the completion response notification cannot be received due to faulty communications, for example, it is determined that there is an error, and the procedure goes to operation S127.

Operation S125: A determination is made as to whether the received completion response is appropriate or not. When the completion response is determined as being appropriate, the procedure goes to operation S126. When the completion response is determined as not being appropriate, it is determined that there is an error, and the procedure goes to operation S127. The appropriateness of the completion response may be determined based on whether the details thereof are meeting the request or not.

Operation S126: A completion notification is made to notify that the completion response is received (empty transmission). When the completion notification cannot be transmitted normally due to faulty communications, for example, it is determined that there is an error, and the procedure goes to operation S127.

Operation S127: The socket 120d for use with the process-to-process communications is released because there is an error. The new process activation procedure is then ended because the process activation has failed.

Operation S128: Because the communications for the new process activation is now completed, the socket 120d for use with the process-to-process communications is released.

Operation S129: Since it is thus determined that the passing of the server function from the server 110a is now completed, the operation state flag 117 is set to indicate the “normal” state.

Operation S130: The heartbeat communications processing section 113b, the service communications processing section 111b, and the service processing section 112b, and the passing of service function to the server 110b are activated. The new process activation procedure is then ended.

The server software may be favorably updated without causing an error to external components of the service provider node 100 such as the monitoring node 500 or the processing request node 600. This accordingly improves operation efficiency of the system during the software update.

Especially when the service provider node operates as a storage server, data under the management of the service provider node may be erroneously generated in another storage server when the service provider node operation is stopped.

When mirroring is performed using a plurality of storage servers, for example, if one of the storage servers stops operating, the entire system suffers from the reduction of reliability. In consideration thereof, data is copied from any of the storage servers operating normally to the storage server for mirroring. Therefore, a simple operation like a software update may cause the need for copying a large amount of data, and this resultantly increases the network load and reduces considerably the operation efficiency of the system. On the other hand, with the technology of the embodiment, the software update causes no error, thereby improving the operation efficiency.

In the embodiment described above, an error is reduced if not prevented from occurring in the monitoring node 500 by increasing the transmission interval of the heartbeats. However, if the time for software update is shorter than the heartbeat interval, the heartbeat interval is not necessarily increased. For increasing the heartbeat interval, the increase is not necessarily a fixed value set to any existing software, and may be determined based on a command from the update command section 720 or from any external components, e.g., the node monitoring section 520 or the processing request section 610, or may be determined in consideration of a notification about the time for software update accepted by external components. Alternatively, the transmission interval of the heartbeats may be increased based on the time for software update estimated by the old server 110a or the new server 110b. When the software update results in a failure with the heartbeat interval, the heartbeat interval may be increased again by a specific length of time to try the software update again.

Note here that the processing functions described above may be implemented by a computer. In this case, a program written with the processing details for functions that are supposed to be provided to the service provider nodes and the monitoring node is provided. By running the program by the computer, the processing functions described above are implemented on the computer. The program written with the processing details may be recorded in a computer-readable recording medium. The computer-readable recording medium includes a magnetic recording device, an optical disk, a magneto-optical disk, a semiconductor memory, and the like. The magnetic recording device is exemplified by a hard disk drive (HDD), a flexible disk (FD), a magnetic tape, and the like. The optical disk is exemplified by a DVD (Digital Versatile Disc), a DVD-RAM (Random-Access Memory), a CD-ROM (Compact Disc Read-Only Memory), a CD-R (Recordable)/RW (ReWritable), and the like. The magneto-optic recording medium is exemplified by a MO (Magneto-Optical Disk).

For distributing the program, a portable recording medium such as a DVD and/or a CD-ROM recorded with the program may be made available for sale. Alternatively, the program may be stored in a storage device of a server computer, and the program may be transferred from the server computer to any other computer over a network.

The computer running the program stores, in its own storage device, a program recorded on a portable recording medium or a program provided by a server computer. The computer reads the program from the storage device of its own, and goes though process execution in accordance with the program. Note here that, alternatively, the computer may directly read the program from the portable recording medium, and perform process execution in accordance with the program. The computer also may, every time any new program is provided from the server computer, successively perform process execution in accordance with the provided program.

While the embodiments of the present invention have been described above, the present invention is not limited to the above-described embodiments and various improvements and modifications are possible without departing from the spirit of the invention.

What is claimed is:

1. A computer-readable recording medium storing a service provider program that causes a computer to execute:
providing a service by accepting a service request;
establishing process-to-process communications by waiting for a process to be a destination of the service;
stopping a provision of the service corresponding to the service request accepted by the providing after the process-to-process communications is established;
transmitting, while the provision of the service is stopped, information for use by the providing to provide the service, to the process by the process-to-process communications; and
ending, after the information is transmitted by the transmitting, the acceptance of the service request by the providing.

2. The computer-readable recording medium according to claim 1, the program further causing the computer to execute:
permitting to start a function-pass procedure with the process establishing the process-to-process communications as the destination of the service provided by the providing, and
wherein the stopping stops the provision of the service after the permitting to start the function-pass procedure.

3. The computer-readable recording medium according to claim 1, wherein the stopping stops the provision of the service by making a response not to answer the accepted service request.

4. The computer-readable recording medium according to claim 2, wherein the computer configures a cluster system that performs decentralized processing, the program further causing the computer to execute:
transmitting, to a monitoring node that monitors the cluster system, a heartbeat packet including heartbeat interval information indicating a preset first heartbeat transmission interval at regular intervals of the first heartbeat transmission interval, and when the permitting is provided to start the function-pass procedure, transmitting, to the monitoring node, the heartbeat packet including, as the heartbeat interval information, a second heartbeat transmission interval longer than the first heartbeat transmission interval.

5. A computer-readable recording medium storing a service provider program that causes a computer to execute:
providing a service through acceptance of a service request;
establishing process-to-process communications by waiting for a process to be a destination of the service;
receiving, from the process, by the process-to-process communications, information for the providing to provide the service; and
starting, after the information is received by the receiving, providing the service by the providing based on the information.

6. The computer-readable recording medium according to claim 5, the program further causing the computer to execute:
requesting to start a function-pass procedure for selecting the process establishing the process-to-process communications as a source of the service, and for selecting the providing as a destination of the service, and
wherein the receiving receives the information in response to the permitting of the request to start the function-pass procedure.

7. The computer-readable recording medium according to claim 5, wherein the computer configures a cluster system that performs decentralized processing, the program further causing the computer to execute:
transmitting, after the information is received by the receiving, a heartbeat packet to a monitoring node monitoring the cluster system at specific transmission intervals.

8. The computer-readable recording medium according to claim 5, the program further causing the computer to execute:
issuing a completion notification of the function-pass procedure for selecting the process establishing the process-to-process communications as a source of the service, and for selecting the providing as a destination of the service, and
wherein a determination as to whether or not the information is received by the receiving is made based on whether a completion response corresponding to the completion notification is received or not.

9. A service provider node comprising:
a first server process execution unit including:
a service provision unit that provides a service through acceptance of a service request;
a process-to-process communications establishing unit that establishes process-to-process communications by waiting for a second server process;
a service provision stop unit that stops a provision of the service asked by the service request accepted by the service provision unit after the process-to-process communications is established;
an information transmission unit that transmits, while the provision of the service is stopped, information for use by the service provision unit to provide the service to the second server process by the process-to-process communications; and
a service end unit that ends, after the information is transmitted by the information transmission unit, the acceptance of the service request by the service provision unit; and
a second server process execution unit including:
another service provision unit that provides the service through acceptance of the service request;
another process-to-process communications establishing unit that establishes the process-to-process communications with the first server process;
an information reception unit that receives, from the first server process by the process-to-process communications, information for use by the another service provision unit to provide the service; and
a service start unit that starts, after the information is received by the information reception unit, the provision of the service by the another service provision unit based on the information.

10. A cluster system in which a plurality of servers perform decentralized processing, the system comprising:
a service request node that makes a service request; and
a service provider node that provides a service in response to the service request, wherein
the service provider node includes:
a first server process that provides the service; and
a second server process that provides the service as an alternative to the first server process, wherein
the first server process includes:
a first service processing unit that makes a response corresponding to the service request through acceptance of the service request; and
a first process-to-process communications unit that performs process-to-process communications, wherein
the second server process includes:
a second service processing unit that makes a response corresponding to the service request through acceptance of the service request; and
a second process-to-process communications unit that performs the process-to-process communications, wherein
the first process-to-process communication unit includes:
a function-pass start permission unit that gives a permission to start a function-pass procedure with the second server process determined as being a destination for the provision of the service through acceptance of the process-to-process communications from the second process-to-process communications unit; and
an information transmission unit that transmits, to the second process-to-process communications unit, information for use by the second server process to provide the service as an alternative to the first server process in response to the permission to start the function-pass procedure,
wherein the first service processing unit includes:
a service stop unit that stops the provision of the service by making a response not to meet the service request accepted after the permission to start the function-pass procedure; and
a service end unit that ends the provision of the service after the information is transmitted by the information transmission unit, and
the second service processing unit includes
a service start unit that starts, after the information is transmitted by the information transmission unit, the provision of the service based on the provided information.
